(19) United States
(12) Patent Application Publication
(10) Pub. No.: US 2010/0295324 A1
(43) Pub. Date: Nov. 25, 2010

(54) DOOR-LOCK DEVICE WITH DUPLEX SAFETY MEASURES

(76) Inventor: Sang Won Sea, Jeollabuk-do (KR)

Correspondence Address: CHRISTOPHER PAUL MITCHELL, 888 16TH ST., NW, SUITE 800, WASHINGTON, DC, 20006, US

(21) Appl. No.: 12/438,729

(22) PCT Filed: Mar. 26, 2008
(86) PCT No.: PCT/KR2008/001671

§ 371 Date: Aug. 11, 2010

(30) Foreign Application Priority Data
Apr. 5, 2007 (KR) 10-2007-0033773

(51) Int. Cl. E05C 5/00

(52) U.S. Cl. 292/65

(57) ABSTRACT

Provided is a door-lock device for the door of electric home-appliances. In the door-lock device, the entrance of a latch allows a safety pin to move and a slider to be released. The slider moves by a solenoid, thus connecting the home-appliance with the electrical source. The door-lock device comprises a micro switch (20) detecting closing and opening of the door; a solenoid (80) actuated by electricity; a slider (30) operated by the solenoid (80) and having a hollow part (31) therein; a safety pin (40) located in the hollow part (31) and elastically supported by a spring (41); a cam (50) rotatably holding the latch (10); and a rocker (60) restricting the rotation of the cam (50) by the slider (30). The latch (10) moves the safety pin (40) out of the hollow part of the slider (30), so the slider (30) can be moved by the solenoid (80).

### TECHNICAL FIELD

The present invention relates to a door-lock device which locks and releases the door of the electric home-appliance, more specifically to a door-lock device wherein the entrance of a latch moves a safety pin, thus releasing a slider from its restricted state, and the actuation of a solenoid moves the slider, thus connecting the electric home-appliance with the electrical source which is necessary for the operation of the electric home-appliance.

### BACKGROUND ART

In the door-lock device 1 of electric home-appliance, a micro switch 20 (refer to FIG. 1) is provided which checks whether or not the door is open.

When the door is closed, it pushes the micro switch 20, and thus it comes to be standby state wherein the electric home-appliance is ready for operation, while when the door is opened the micro switch 20 is out of the pushed state and thus the electric home-appliance ceases to be operating.

When the micro switch 20 detects that the door is closed, the solenoid is provided with the electricity through actuation signal by the user to actuate the solenoid, and thus the contact terminal is energized through the actuation of the solenoid, and thus the electric home-appliance is operated.

In the door-lock device shown in FIG. 1, when the micro switch 20 is pushed by artificial pressure under the condition where the door is open, the micro switch 20 perceives that the door is closed, thus converting to the standby state.

Under the standby state, the electric home-appliance can be operated at any time, thereby the user is exposed to danger caused by the operation without previous warning.

### DISCLOSURE OF INVENTION

### Technical Problem

In the present invention for solving said problem, in case the micro switch 20 is pushed by the closure of the door and is converted to the standby state, the slider moved by the solenoid is restricted by a safety pin from moving, and the safety pin is moved by the entrance of the latch thereby the slider being movable and the electric home-appliance being operated, and thus the door-lock device with duplex safety measures is provided.

### Technical Solution

The door-lock device with duplex safety measures of the electric home-appliance for accomplishing the purpose of the present invention comprises, a micro switch 20 which detects whether the door is closed and opened; a solenoid 20 which is operated by supplied electric power; a slider 30 which is provided with hollow part 31 in its inner area and is moved by the actuation of the solenoid 80; a safety pin 40 which is located in the hollow part 31 of the slider 30 and is elastically supported by the elastic spring 41; a cam 50 which can be rotated and supports the entering latch 10; and a rocker 60 which prevents the rotation of the cam 50 caused by the movement of the slider 30, wherein the latch 10, the hollow part 31 of the slider 30 and the safety pin 40 are position on a coaxial line, and the entrance of the latch 10 moves the safety pin 40 out of the hollow part 31 of the slider 30, thereby the slider 30 being movable by the actuation of the solenoid 80.

Desirably, the cam 50 is made of a pair of hook-shaped elements facing each other, groove 511, 522 are provided in the central part of the respective cam 51, 52, and the safety pin 40 is introduced in the groove 511, 52 by the entrance of the latch 10.

Further, the rocker 60 is positioned between the one pair of the cam 50 by the movement of the slider 30, so that it restricts the rotation of the cam while the electric home-appliance is operating, thereby the opening of the door being prevented.

### Advantageous Effects

According to the present invention, in case the micro switch 20 is pushed by the closure of the door and is converted to the standby state, the slider is restricted from moving by the safety pin located in the hollow part of the slider, and without the entrance of the latch the electric home-appliance cannot be operated, therefore the door-lock device with duplex safety measures is provided.

Further, while the electric home-appliance is operating, the rocker prevents the cam from rotating, and thus the release of the latch is prevented.

### BRIEF DESCRIPTION OF THE DRAWINGS

FIG. 1 shows the perspective view of door-lock device of the art.

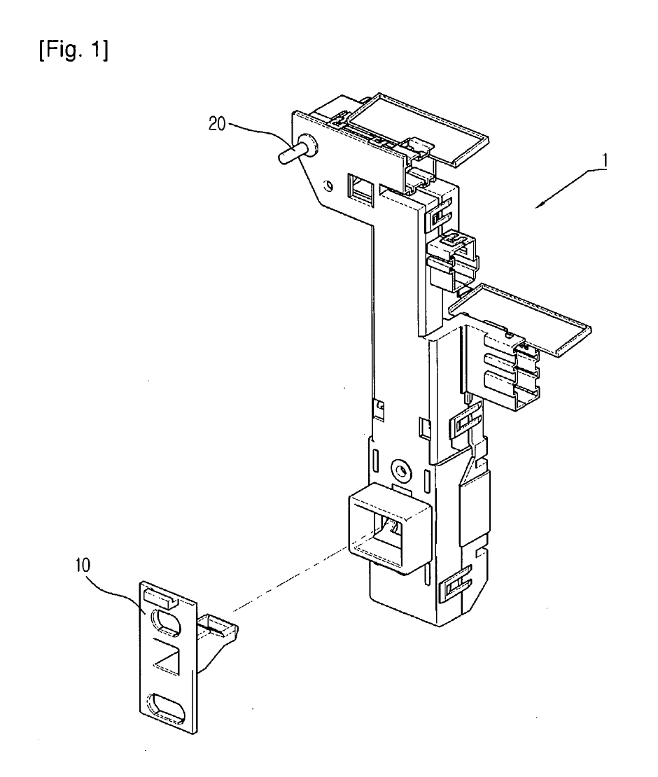

FIG. 2 shows the disassembled view of the door-lock device according to the present invention.

FIG. 3 shows the perspective view of the safety pin, cam and rocker.

FIG. 4 shows the plane view of the door-lock device before the latch enters.

FIG. 5 shows the cross-sectional view of A-A plane of FIG. 4.

FIG. 6 shows the plane view of the door-lock device after the latch enters.

FIG. 7 shows the cross-sectional view of b-B plane of FIG. 7.

### REFERENCE NUMERALS FOR THE PRIMARY ELEMENTS IN THE DRAWINGS

10 . . . latch 20 . . . micro switch

21 . . . base 22 . . . cover

30 . . . slider 31 . . . hollow part

36 . . . rocker operation protrusion

37 . . . contact terminal movement protrusion

40 . . . safety pin 41 . . . elastic spring

50, 51, 52 . . . cam

60 . . . rocker 61 . . . rocker elastic spring

70 . . . contact terminal 80 . . . solenoid

### BEST MODE FOR CARRYING OUT THE INVENTION

Hereinafter, the door-lock device with duplex safety measures according to the present invention is described with reference to the attached drawings.

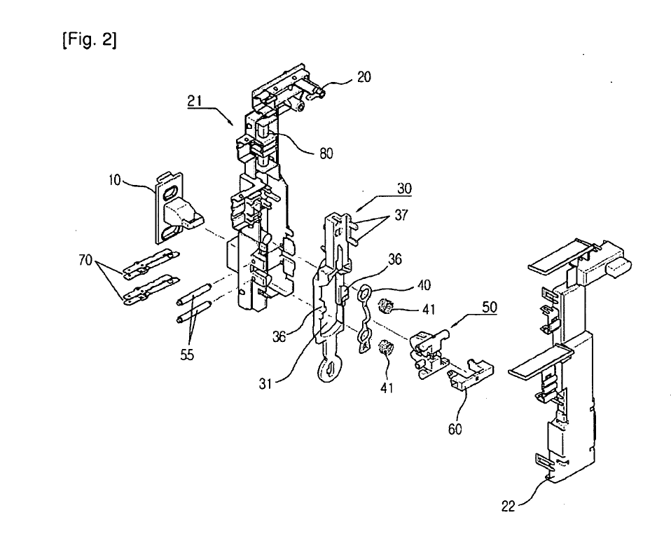

FIG. 2 shows the disassembled perspective view of the door-lock device according to the present invention.

As for the constitution, the door-lock device according to the present invention comprises a micro switch 20 which detects whether the door is closed and opened and is located in the area formed by a base 21 and a cover 22 which prevent the inner constitutional elements from rotating, moving and releasing; a solenoid 20 which is operated by supplied electric power; a slider 30 which is provided with hollow part 31 in its inner area and is moved by the actuation of the solenoid 80; a safety pin 40 which is located in the hollow part 31 of the slider and is elastically supported by the elastic spring 41; a cam 50 which can be rotated and supports the entering latch 10; and a rocker 60 which prevents the rotation of the cam 50 caused by the movement of the slider 30, wherein the latch 10, the hollow part 31 of the slider 30 and the safety pin 40 are position on a coaxial line, and the entrance of the latch 10 moves the safety pin 40 out of the hollow part of the slider 30, thereby the slider 30 can be moved by the actuation of the solenoid 80.

Wherein, the fin 55 releases and rotates the cam 50.

In the above, although the contact terminal through which electricity is supplied by the solenoid 80 is not described, such constitution as solenoid is energized and is actuated, which causes the slider to be moved, and thus the contact terminal is supplied with electricity by the contact terminal movement protrusion 37 of the slider is already known in the art and thus easily understood by an ordinary-skilled person of the art.

In the present invention, the slider 30 is formed to be provided with the hollow part 31 through which the latch 10 is passed, and the safe pin 40 is positioned on the entrance line of the latch 10, so that the latch 10 pushes the safety pin 40 passing through the hollow part of the slider 30.

Therefore, while the latch 10 does not enter, the safety pin 40 is positioned in the hollow part 30 of the slider 30 and restricts the slider 30 from its moving, and thus the slider 30 does not move even when the solenoid 80 is actuated due to the energization.

Hereinafter, the safety pin, the cam and the rocker according to the present invention are described in detail.

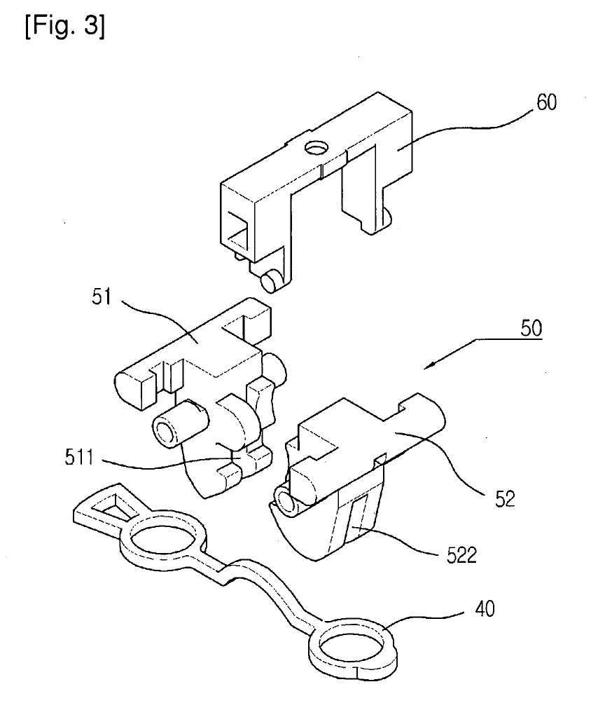

FIG. 3 shows the perspective view of the safety pin, the cam and the rocker according to the present invention.

The cam 50 is made of a pair of hook-shaped elements 51, 52 facing each other, groove 511, 522 are provided in the central part of the cam 51, 52. When the latch 10 enters, the safety pin 40 is introduced in the groove 511, 522.

That is to say, when the latch enters, the safety pin 40 is inserted by the latch 10 in the groove 511, 522 which are formed on the cam 50, thereby the safe pin 40 being out of the hollow part 31 of the slider 30.

Desirably, predestined bended part is formed on the part of the safety pin 40 which engages with the latch 10.

On the side frame which forms the hollow part of the slider 30, rocker operation protrusion 36 is provided which engages with the rocker 60 (see FIG. 2).

The rocker operation protrusion 60 is provided with a predestined tilt angle, such that the rocker 60 is moved along the tilt angle by the movement of the slider 30.

The rocker operation protrusion 60 is provided with a predestined groove which moves the rocker 60 in the left and right direction (as shown in the fig.) according to the movement of the rocker operation protrusion 60, while the rocker 60 is provided with protrusion which is moved along the groove, therefore the protrusion is moved along the groove.

The rocker 60 is positioned between the one pair of cam 51,52 which facing each other and is operated by the movement of the slider 30, and is inserted between the cam 51 and cam 52 by the movement of the slider 30, thereby restricting the rotation of the cam 51,52.

The operation of the rocker would be fully understood with reference to the operational plane view and cross-sectional view in the below.

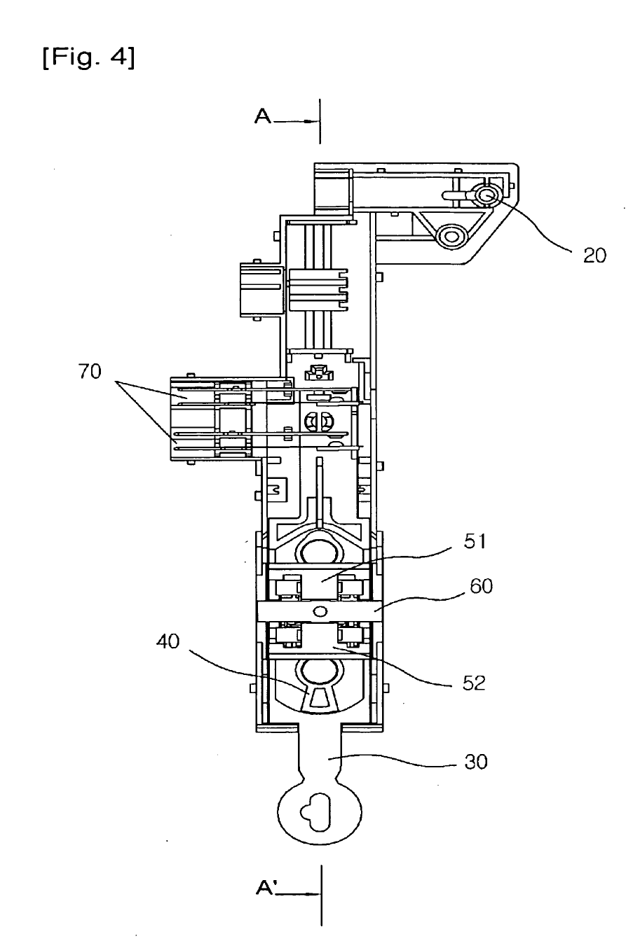

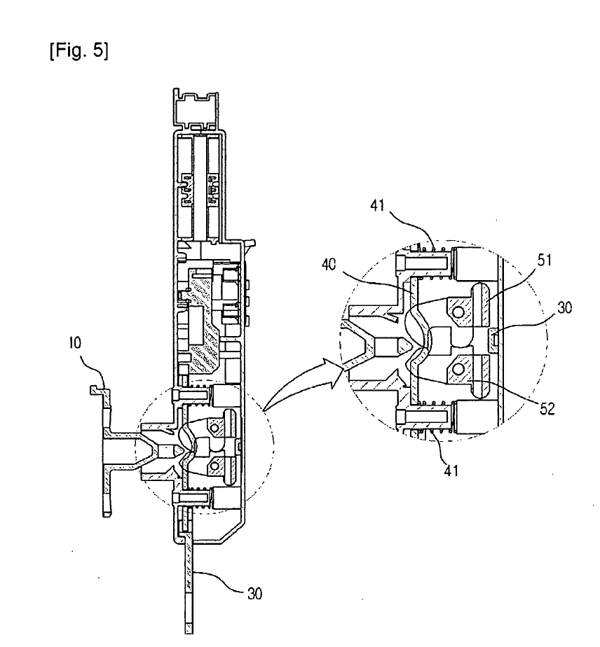

FIG. 4 show the plane view of the door-lock device before the latch enters, while FIG. 5 shows the cross-sectional view of A-A plane of FIG. 4.

Until the latch 10 enters, the safety pin 40 is positioned in the hollow part of the slider 30 on the latch entrance line, and is introduced to the groove 511,522 formed on the cam 51, 52.

The safety pin 40 is elastically supported by the elastic spring 41.

Under the above condition, since the safety pin 40 is positioned in the slider 40, the slider 30 is prevented from moving.

Further, the rocker 60 is positioned in the upper part(right area in the drawing) of the cam 51, 52 facing each other, so that it does not restrict the rotation of the cam 51,52.

Hereinafter, the state is described where the latch entered.

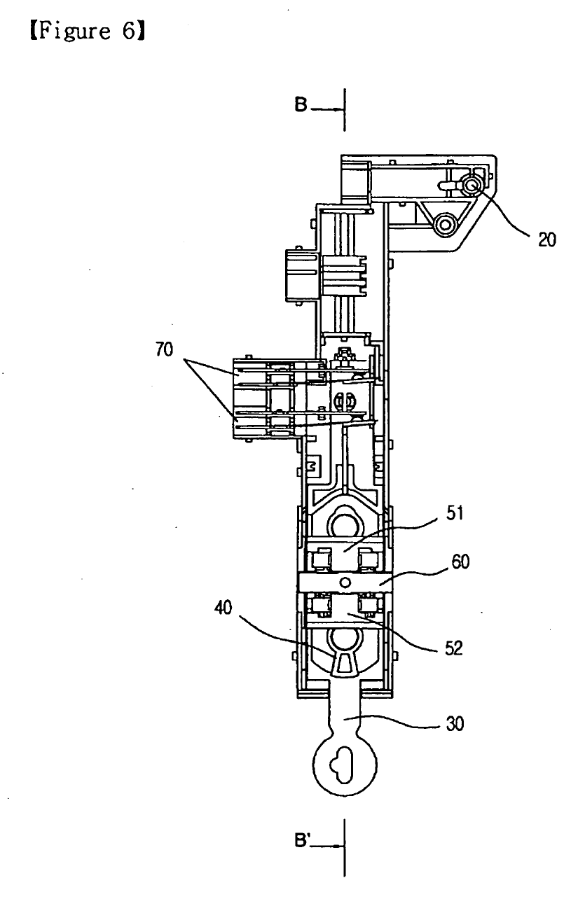

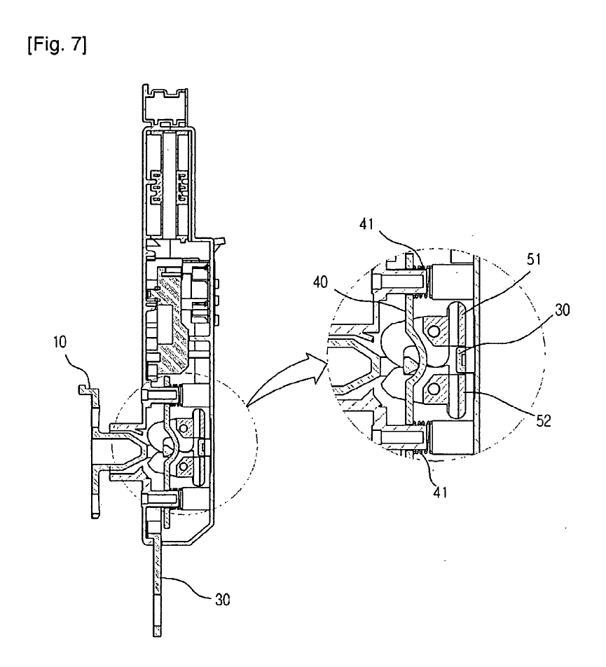

FIG. 6 shows the plane view of the door-lock device after the latch enters, while FIG. 7 shows the cross-sectional view of B-B′of FIG. 6.

As latch 10 enters, it pushes the safety pin 40 from left to right (in the right direction in the drawings), the safety pin 40 is out of the hollow part 31 of the slider 30, and thus it does not restrict the slider 30 any more.

Under the above state, the safety pin 40 can be moved within predestined range, and when the signal by the user is transmitted to the solenoid 80 through the contact terminal, the solenoid 80 is actuated, so that the slider 30 is moved to the upper area (in the upper direction in the drawings).

The rocker 60 is inserted into the inner area of the rotational radius of the cam 51, 52, along the tilt angel of the rocker operation protrusion 36 provided on the side frame which forms the hollow part 31 of the slider 30 by the movement of the slider 30, and thus the cam 51,52 is prevented from rotating.

In the present invention, the slider 30 can be moved only after the safety pin 40 is moved off the hollow part 31 of the slider 30 by the entrance of the latch 10.

In the door-lock device of the ordinary electric home-appliance, the cam is provided with latch part which holds and grasps the latch and is made of single unit. In the present invention, the cam is comprised of a pair of facing element, however, it can be made of single unit. The shape of the cam is subject to various modification by the ordinary-skilled person of the art, which falls within the scope of the present invention and the scope of the claims is not to be limited or narrowed by the drawings which illustrates the embodiment of the present invention.

1. The door-lock device with duplex safety measures comprising,
a micro switch 20 which detects whether the door is closed and opened;
a solenoid 20 which is operated by supplied electric power;
a slider 30 which is provided with hollow part 31 in its inner area and is moved by the actuation of the solenoid 80;
a safety pin 40 which is located in the hollow part 31 of the slider 30 and is elastically supported by the elastic spring 41;
a cam 50 which can be rotated and supports the entering latch 10;
and a rocker 60 which prevents the rotation of the cam 50 caused by the movement of the slider 30,
wherein the latch 10, the hollow part 31 of the slider 30 and the safety pin 40 are position on a coaxial line,
and the entrance of the latch 10 moves the safety pin 40 out of the hollow part 31 of the slider 30, thereby the slider 30 being movable by the actuation of the solenoid 80.

2. The door-lock device according to claim 1,
Wherein the cam 50 is made of a pair of hook-shaped elements facing each other, groove 511, 522 are provided in the central part of the cam 51, 52, and the safety pin 40 is introduced in the groove 511, 52 by the entrance of the latch 10.

3. The door-lock device according to claim 1,
Wherein the rocker 60 is positioned between the one pair of the cam 50 by the movement of the slider 30, thereby restricting the rotation of the cam.

4. The door-lock device according to claim 1,
Wherein the part of the safety pin 40 which engages the latch is provided with a predestined bended part along the entrance direction of the latch.
